(19) United States
(12) Patent Application Publication
(10) Pub. No.: US 2007/0274619 A1
(43) Pub. Date: Nov. 29, 2007

(54) Tribological Device

(76) Inventors: Mathias Woydt, Berlin (DE); Martin Engler, Leutkirch (DE); Peter Moesle, Leutkirch (DE)

Correspondence Address: William D. Breneman;Breneman & Georges, 3150 Commonwealth Avenue, Alexandria, VA, 22305, US

(21) Appl. No.: 10/577,740

(22) PCT Filed: Oct. 27, 2004
(86) PCT No.: PCT/DE04/02387

§ 371 Date: Mar. 27, 2007

(30) Foreign Application Priority Data
Nov. 3, 2003 (DE) 103 51 562.3

(51) Int. Cl. F16C 32/00

(52) U.S. Cl. 384/461; 384/625; 75/383

(57) ABSTRACT

The invention relates to a tribological device, in particular a miniature anti-friction bearing, with rolling bodies which are resistant to superheated steam up to a component temperature of 450 degrees and which travel along roller tracks, the structure of the rolling bodies being based on zirconium dioxide. According to the invention, this object is achieved by the fact that at least the surface of the rolling bodies consists of zirconium dioxide that is stabilized with MgO and/or CeO₂ and/or Sc₂O₃, the zirconium oxide at least partially having a tetragonal structure. In a further embodiment of the invention, the stabilization is achieved with Y₂O₃, the primary particle size being less than 300 nm, preferably less than 100 nm.

The invention relates to a tribological device according to the preamble of claim 1.

Tribological devices in the form of anti-friction bearings are used in many different kinds of machines and appliances. The individual bearing components have to be able to satisfy a wide variety of requirements depending on the field of application.

In medical appliances, for example in dental turbines, there are a whole range of exceptional requirements. Thus, these bearings have to be made very small in the form of so-called miniature ball bearings, but must withstand very high speeds of rotation (up to about 500,000 rpm). Therefore, miniature ball bearings of this kind are produced with a very high degree of precision, and the materials chosen for this purpose are ones that permit this type of precision working and that withstand high mechanical loads.

In addition to the aforementioned requirements, many medical appliances, for example a dental drill, have the additional requirement that all the components have to be extremely stable in terms of temperature. This is because, after each treatment, such an appliance is sterilized at 134° C. for at least 3 minutes in saturated steam at a pressure of 2 bar. The dynamics of the physical parameters, i.e. for example the time-related changes in temperature, humidity and pressure, can in this case assume extreme values.

Therefore, a switch has been made to ceramic balls composed of silicon nitride.

Compared to silicon nitride, zirconium dioxide affords the advantage that the modulus of elasticity and the linear thermal expansion of zirconium dioxide is much closer to the corresponding values of the metals (for example corrosion-resistant steel with material number 1.4125 according to EN 10027) that are normally used for the other appliance parts and bearing parts, for example the bearing rings.

To obtain zirconium dioxide at normal ambient temperature, e.g. room temperature, with sufficient mechanical properties, Y₂O₃ has hitherto been used as a stabilizing additive. In this way, a tetragonal structure can at least in part be obtained as metastable state.

However, this material has the disadvantage that, under sterilization conditions, i.e. under the action of saturated superheated steam at high temperature, this metastable state can be lost and, with it, the associated mechanical properties.

Therefore, bearings using zirconium dioxide have hitherto been unsuitable for sterilizable appliances, such as dental handpieces.

The object of the invention is therefore to propose a tribological device with rolling bodies for use in sterilizable appliances, such as dental handpieces, etc., in which at least the surface is constructed on the basis of zirconium dioxide.

Starting out from a tribological device of the type mentioned in the introduction, this object is achieved by the characterizing features of claim 1 or of claim 3.

Advantageous embodiments and developments of the invention are possible with the measures set forth in the dependent claims.

Accordingly, a device according to the invention is characterized in that at least the surface of the rolling bodies consists of zirconium dioxide that is stabilized with additives, the zirconium dioxide having at least partially a tetragonal structure.

The stabilizing additive proposed according to claim 1 is MgO, CeO₂ or Sc₂O₃. Combinations of two such substances or of all three substances are also possible in order to achieve the desired mechanical and thermal properties, these properties being stable with respect to superheated steam, i.e. they are maintained intact after a large number of sterilization operations with superheated steam. The amounts of the additives will be chosen depending on the nature of the corresponding properties. The stabilizing additives serve principally to maintain the tetragonal structure at room temperature.

In another embodiment of the invention, Y₂O₃ is used as the additive for stabilizing the tetragonal structure of the zirconium dioxide; it should be noted here that the zirconium dioxide has a primary particle size of less than 300 nm, preferably of less than 100 nm. The stabilizing effect is in this case effected by the surface energy. When using Y₂O₃, it has been found that the primary particle size of the zirconium dioxide in the stated order of magnitude is decisive for the required resistance to superheated steam in the temperature ranges cited above. Y₂O₃ can also be used in combination with one or more of the additives cited above.

In the case of the other additives cited above, a suitable choice of the primary particle size before pressing to the ceramic according to the invention in the range of less than 100 nm, preferably of less than 300 nm, is likewise advantageous for strengthening the stabilizing effects, but, with these additives, sufficient results in terms of resistance to steam degradation are achievable even with larger particle sizes.

The invention is based on the realization that, to achieve the desired temperature properties in conjunction with the desired material stability in respect of superheated steam, a combination of measures is necessary. One of these measures involves at least partly forming a tetragonal structure in the zirconium dioxide. The other measure involves incorporating additives for stabilizing the tetragonal structure of the zirconium dioxide at low temperatures, e.g. at room temperature. In this way, it is possible to create the required thermal and mechanical properties in the area of the zirconium dioxide. Rolling bodies according to the invention can readily be used within the range of the required sterilization time, temperature and pressure with saturated superheated steam (3 min/134° C./2 bar/100% rel. humidity), i.e. they comply for example with the standard E DIN EN 13060:2002. They are also in some cases resistant to superheated steam up to a component temperature of 450° C.

Preferably at least half of the zirconium dioxide, relative to its mass, has a tetragonal structure, in order to exploit the positive effect of such a structure. In extreme cases, the zirconium dioxide can be present also more or less completely in the tetragonal structure, i.e. as so-called TZP (tetragonal zirconia polycrystal).

In a particularly advantageous embodiment of the invention, at least one rolling body is produced completely from a zirconium dioxide that is stabilized with additive and that has a predominantly tetragonal structure, so that it is possible to dispense with a complicated link between a coating and a substrate, which would also have to be resistant to superheated steam and have a high degree of mechanical strength.

In a development of this embodiment, all the rolling bodies of an anti-friction bearing are made from a zirconium dioxide that is stabilized according to the invention. This on the one hand reduces the number of different components required for a device according to the invention. In addition, if all the rolling bodies are made from stabilized zirconium dioxide according to the invention, this ensures that all the rolling bodies have the appropriate resistance and thermal loading capacity, so that loading capacity of the anti-friction bearing is not impaired for example by a differently configured rolling body. Moreover, by this means it is possible to reliably avoid a situation in which any differences in the density of the rolling bodies cause problems in the running of the bearing.

The rolling bodies according to the invention are especially suitable for fast-running miniature bearings in which the rolling bodies have a radius of ≦4 mm.

In a specific embodiment of the invention, the rolling bodies are designed as balls. Accordingly, the tribological device forms a ball bearing. It is easily possible, however, for a rolling body according to the invention to be designed also as a roller or needle body in order to realize a roller bearing or needle bearing.

In the case of a roller bearing, the rollers provided as rolling bodies are preferably provided with an axial, elliptic or parabolic edge drop. Such an edge drop ensures a continuous falling off of the load at the axial edge region, so that here excess stresses are avoided. Moreover, an axial edge drop of this kind facilitates the axial guiding of the roller bodies. Moreover, such a rolling body without a rim is easy to produce from ceramic material such as zirconium dioxide.

In order to achieve the desired thermal and mechanical properties of the rolling bodies according to the invention, different combinations of structures and quantities of additives are possible.

Thus, sufficient stabilizing can be achieved with an addition of 0.5 to 5 percent by weight of MgO. Moreover, the desired result can be achieved by a structural distribution of cubic, tetragonal and monoclinic structures, a tetragonal structure predominantly being provided, and the monoclinic zirconium dioxide phase accounting for less than 10 percent by weight.

Moreover, in a particular embodiment, stabilizing of the zirconium dioxide with 8 to 10 percent by weight of CeO₂ has proven advantageous. When adding Sc₂O₃, an amount in the region of 0.5 to 13 mol percent has proven suitable.

In the case of stabilization by means of Y₂O₃, good results are achieved by addition of a quantity of 0.1 to 4.5 percent by weight in conjunction with the primary particle sizes mentioned above.

To improve the desired property, it is also advantageous if the zirconium dioxide has substantially, i.e. as far as possible, a tetragonal structure.

It has also proven advantageous to add further additives, for example Al₂O₃ and/or Cr₂O₃, to the stabilized zirconium dioxide according to the invention. Such additives are suitable for stabilizing the tetragonal structure of the ZrO₂ even under sterilization conditions, i.e. in a superheated steam environment. Good results were achieved here with 0.5 to 0.9 percent by weight of one or both substances, said additive or additives either being dissolved in the zirconium dioxide lattice or forming phases with the zirconium dioxide stabilized according to the invention.

The rolling bodies are preferably produced from zirconium dioxide stabilized according to the invention using what is called the sol-gel process. The sol-gel process is a chemical synthesis of ceramic materials to form sols and subsequent conversion to a gel, and further processing.

Another process for producing rolling bodies is to sinter zirconium dioxide from a powder, preferably with the above-cited structure. The sintering of the rolling bodies can be done here in different ways, for example by pressureless sintering and/or gas pressure sintering and/or hot isostatic sintering.

The aforementioned production processes are described in detail in the standard ENV 14232.

With all these processes, rolling bodies according to the invention can be produced as long as the essential features of the invention are observed, i.e. the described additives for stabilizing the zirconium dioxide are added and the available process parameters and selection of the raw material are done such that the required proportion of tetragonal structure is to be found in the finished rolling body. A small proportion of impurities, for example Fe₂O₃, SiO₂, TiO₂, CaO, etc., does not cause any real problem here.

Different illustrative embodiments of the invention are shown in the figures and set forth in the tables and are explained in greater detail below.

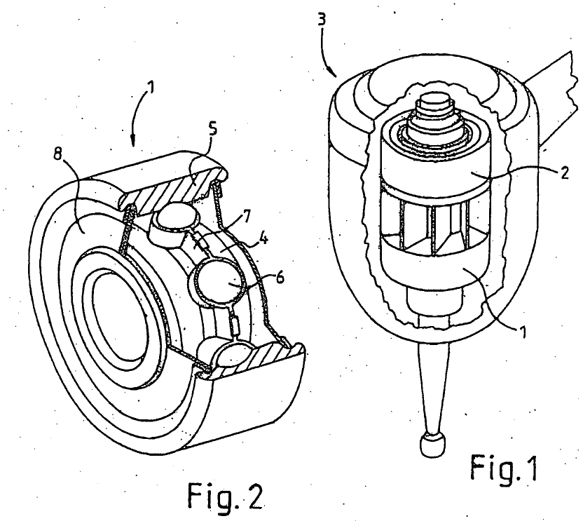

FIG. 1 shows a perspective, transparent view of a dental turbine, and

FIG. 2 shows a perspective view of an associated ball bearing.

In FIG. 2, the two ball bearings 1 and 2 can be seen on both sides of the turbine wheel in the head 3 of the associated dental handpiece. Each ball bearing 1, 2 contains an inner bearing ring 4 and an outer bearing ring 5 between which bearing balls 6 run in corresponding tracks and are fixed in a bearing cage 7. In the axial direction, each ball bearing 1, 2 is closed off by cover disks 8.

According to the invention, bearing balls 6 are now provided which in accordance with the features of claim 1 are produced on the basis of zirconium dioxide. The table below illustrates some possible compositions of zirconium dioxide balls.

ZrO₂ balls

| | | |
|---|---|---|
| No. | mol. % Y₂O₃ | mol. % CeO₂ |

| | | | | |
|---|---|---|---|---|
| 1 | 3.9 | mol. % Y₂O₃ | 0.1 | mol. % CeO₂ |
| 2 | 3.5 | mol. % Y₂O₃ | 0 | mol. % CeO₂ |
| 3 | 0 | mol. % Y₂O₃ | 16 | mol. % CeO₂ |

The ceramic compositions listed above by way of example can be used to obtain, by one of the described methods, bearing balls that have the required sterilization resistance and the required mechanical strength, the aforementioned primary particle sizes having to be observed for Y₂O₃. Another illustrative embodiment involves, for example, ZrO₂ balls with 21 percent by weight of CeO₂ and 0.6 percent by weight of Al₂O₃ to stabilize the tetragonal phase of the zirconium dioxide.

Balls according to the invention and with a diameter of 1 mm have breaking loads in excess of 200 N, and, depending on composition, of up to 400 N or more.

Finished balls were tested over 1000 and 2000 sterilization cycles and subjected to different pressure loads. Balls according to No. 3 in the above table with a diameter of 1 mm exhibited a very slight loss of compression load of less than 5%.

### List of Reference Numbers

1 ball bearing
2 ball bearing
3 head
4 inner bearing ring
5 outer bearing ring
6 bearing ball
7 bearing cage
8 cover disks

1. A tribological device, in particular a miniature anti-friction bearing, with rolling bodies which travel along roller tracks, at least one rolling body consisting at least partially of zirconium dioxide that is stabilized with an additive, and the zirconium dioxide having at least partially a tetragonal structure, characterized in that at least the surface of the rolling body consists of zirconium dioxide that is stabilized with MgO and/or CeO₂ and/or Sc₂O₃.

2. The device as claimed in one of the preceding claims, characterized in that the zirconium dioxide has a primary particle size of less than 300 nm, preferably of less than 100 nm.

3. A tribological device, in particular a miniature anti-friction bearing, with rolling bodies which travel along roller tracks, at least one rolling body consisting, at least on the surface, of zirconium dioxide that is stabilized with Y₂O₃, and the zirconium dioxide having at least partially a tetragonal structure, in particular as claimed in claim 1, characterized in that the zirconium dioxide has a primary particle size of less than 300 nm, preferably of less than 100 nm.

4. The tribological device as claimed in claim 1, characterized in that, relative to its mass, at least half of the zirconium dioxide has a tetragonal structure.

5. The device as claimed in one of the preceding claims, characterized in that almost the entire zirconium dioxide has a tetragonal structure.

6. The device as claimed in one of the preceding claims, characterized in that at least one rolling body consists completely of zirconium dioxide that is stabilized with an additive.

7. The device as claimed in one of the preceding claims, characterized in that all the rolling bodies of an anti-friction bearing consists of stabilized zirconium dioxide.

8. The device as claimed in one of the preceding claims, characterized in that the rolling bodies have a radius of ≦4 mm.

9. The device as claimed in one of the preceding claims, characterized in that the rolling bodies are balls.

10. The device as claimed in one of the preceding claims, characterized in that the rolling bodies are rollers or needles.

11. The device as claimed in one of the preceding claims, characterized in that the rollers have an axial, elliptic or parabolic edge drop.

12. The device as claimed in one of the preceding claims, characterized in that the zirconium dioxide is stabilized with 0.5 to 5 percent by weight of MgO.

13. The device as claimed in one of the preceding claims, characterized in that the zirconium dioxide comprises a proportion with a cubic, tetragonal and less than 10 percent by weight monoclinic zirconium dioxide phase.

14. The device as claimed in one of the preceding claims, characterized in that the zirconium dioxide is stabilized with 8 to 26 percent by weight of CeO₂.

15. The device as claimed in one of the preceding claims, characterized in that the zirconium dioxide is stabilized with 0.5 to 13 percent by weight of Sc₂O₃.

16. The device as claimed in one of the preceding claims, characterized in that the zirconium dioxide is stabilized with 0.1 to 4.5 percent by weight of Y₂O₃.

17. The device as claimed in one of the preceding claims, characterized in that 0.5 to 0.9 percent by weight of Al₂O₃ and/or Cr₂O₃ are added, said additive or additives being dissolved in the zirconium dioxide lattice or forming phases with the zirconium dioxide that is stabilized according to one of the preceding claims.

18. The device as claimed in one of the preceding claims, characterized in that the rolling bodies are produced from zirconium dioxide by the sol-gel process.

19. The device as claimed in one of the preceding claims, characterized in that the rolling bodies are sintered from zirconium dioxide.

20. The device as claimed in one of the preceding claims, characterized in that the rolling bodies are sintered by pressureless sintering and/or gas pressure sintering and/or hot isostatic sintering.
